(19) United States
(12) Patent Application Publication
(10) Pub. No.: US 2021/0409385 A1
(43) Pub. Date: Dec. 30, 2021

(54) METHOD AND APPARATUS FOR AUTHENTICATING A DEVICE OR USER

(71) Applicant: Nokia Solutions and Networks Oy, Espoo (FI)

(72) Inventor: Yingchen WANG, Shanghai (CN)

(21) Appl. No.: 17/292,243

(22) PCT Filed: Nov. 23, 2018
(86) PCT No.: PCT/CN2018/117274

§ 371 Date: May 7, 2021

(51) Int. Cl. H04L 29/06

(52) U.S. Cl. CPC H04L 63/0442; H04L 63/083; H04L 63/0823

(57) ABSTRACT

Methods and apparatus are disclosed for authenticating a device. A method may comprise: receiving from a server, a private key of a public-private key pair and a related certificate, wherein the certificate comprises a public key of the public-private key pair; authenticating the first device to the second device through a first Secure Shell session; transmitting to the second device, the certificate in response to a successful authentication of the first Secure Shell session; and authenticating the first device to the second device through a second Secure Shell session by using the public key.

### FIELD OF THE INVENTION

Embodiments of the disclosure generally relate to information secure technology, and more particularly, to authentication of a device or user over a network.

### BACKGROUND

Generally, access to computing resources and data may be limited to authorized devices or users. For example, in an OAM (Operations, Administration and Management) system for broadband access, terminals such as ONT (Optical Network Termination) or CPE (Customer Premises Equipment) may be deployed remotely in end-user's home to provide data, voice, and/or video services. Normally, for telecom customers, optical network unit management and control interface (OMCI) is used for gigabit-capable passive optical network (GPON) management, and TR69/WEB is used for RG (Residential Gateway) management. FIG. 1 shows such an OAM system 100. As shown in FIG. 1, a first maintenance device 112 may provide OAM services to a customer via a channel 102 of OMCI to ONT 120. A second maintenance device 114 may provide OAM services to the customer via a channel 104 of TR-069 to ONT 120/CPE 122. A third maintenance device 116 may provide OAM services to the customer via a channel 106 of WEB to ONT 120/CPE 122.

Customer's OAM requirements, including some simple troubleshooting requirements such as show log, ping ip etc. These OAM requirements can be processed via channels of OMCI, TR69, and/or WEB. The related OAM operations are customized per customer's requirements, and generally restricted to minimum privileges.

While there are cases that are not designed (and cannot be handled) in formal OMCI/TR69/WEB OAM. For example, some of remote devices served by a maintenance device go into fault state and need remote troubleshooting/maintenance. Some security weaknesses are exposed or some manufacture issues are found in the deployed devices, for which the maintenance device need to fix the weaknesses/issues in all of the remote devices served by the maintenance device. These kinds of cases are not customer's requirements. It may be up to the device's vendor or a network operator to conduct operations of remote troubleshooting/fixing/maintenance. These operations have much more privileges, and thus need stricter authentication.

For above cases, it would be advantage to build up an independent secure channel to provide the services of remote troubleshooting/operation/maintenance.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to first aspect of the disclosure, it is provided a method implemented at a first device for authenticating the first device to the second device. Said method may comprise

In an embodiment, the method performed at a first device for authenticating the first device to the second device is provided. The method comprises receiving from a server, a private key of a public-private key pair and a related certificate. The certificate comprises a public key of the public-private key pair. The method further comprises authenticating the first device to the second device through a first Secure Shell session; and transmitting to the second device, the certificate in response to a successful authentication of the first Secure Shell session. The method further comprises authenticating the first device to the second device through a second Secure Shell session by using the public key.

In an embodiment, in the first Secure Shell session, authenticating the first device may comprise sending to the second device, a password or a fixed public key of the first device, so that the first device is authenticated based on the password or the fixed public key.

In an embodiment, in the second Secure Shell session, authenticating the first device may comprise sending the public key to the second device.

In an embodiment, the certificate may be signed by a private key of a certificate of an original certificate authority.

In an embodiment, the certificate may further comprise at least one of the following items: a validity period defining a valid period of the public key; and an indication indicating a usage scope of the public key.

In an embodiment, the certificate may be an X.509 version 3 certificate.

According to second aspect of the disclosure, it is provided a method to be performed at a second device for authenticating a first device. The method comprises authenticating the first device through a first Secure Shell session; receiving from the first device, a certificate in response to a successful authentication result of the first Secure Shell session, wherein the certificate comprises a public key of a public-private key pair associated with the first device; and authenticating the first device through a second Secure Shell session by using the public key.

In an embodiment, in the first Secure Shell session, authenticating the first device may comprise receiving from the first device, a password or a fixed public key to authenticate the first device based on the password or the fixed public key.

In an embodiment, in the second Secure Shell session, authenticating the first device may comprises receiving the public key to the second device; and validating the received public key against the public key in the certificate.

In an embodiment, the certificate may be signed by a private key of a certificate of an original certificate authority. The certificate may further comprise at least one of the following items: a validity period defining a valid period of the public key; and an indication indicating a usage scope of the public key.

In an embodiment, the method may further comprise validating the certificate by doing at least one of the following checks: check the signature of the certificate, check the certificate against a certificate revocation list, check the usage scope against a pre-configured condition, and check whether the validity period is expired. The method may further comprise extracting the public key from the certificate in case the certificate is successfully validated.

In an embodiment, the certificate may be an X.509 version 3 certificate.

According to third aspect of the disclosure, it is provided an apparatus. Said apparatus may comprise at least one processor, at least one memory including computer program code, the memory and the computer program code configured to, working with the at least one processor, cause the apparatus to receive from a server, a private key of a public-private key pair and a related certificate, wherein the certificate comprises a public key of the public-private key pair; authenticate the first device to the second device through a first Secure Shell session; transmit to the second device, the certificate in response to a successful authentication of the first Secure Shell session; and authenticate the first device to the second device through a second Secure Shell session by using the public key.

According to fourth aspect of the disclosure, it is provided an apparatus. Said apparatus may comprise at least one processor, at least one memory including computer program code, the memory and the computer program code configured to, working with the at least one processor, cause the apparatus to authenticate the first device through a first Secure Shell session; receive from the first device, a certificate in response to a successful authentication result of the first Secure Shell session, wherein the certificate comprises a public key of a public-private key pair associated with the first device; and authenticate the first device through a second Secure Shell session by using the public key.

According to fifth aspect of the present disclosure, it is provided a computer readable storage medium, on which instructions are stored, when executed by at least one processor, the instructions cause the at least one processor to perform the method according to the first aspect.

According to sixth aspect of the present disclosure, it is provided a computer readable storage medium, on which instructions are stored, when executed by at least one processor, the instructions cause the at least one processor to perform the method according to the second aspect.

According to seventh aspect of the present disclosure, it is provided computer program product comprising instructions which when executed by at least one processor, cause the at least one processor to perform the method according to the first aspect.

According to eighth aspect of the present disclosure, it is provided computer program product comprising instructions which when executed by at least one processor, cause the at least one processor to perform the method according to the second aspect.

These and other objects, features and advantages of the disclosure will become apparent from the following detailed description of illustrative embodiments thereof, which is to be read in connection with the accompanying drawings.

### BRIEF DESCRIPTION OF THE DRAWINGS

FIG. 1 schematically shows an OAM system in which embodiments of the present disclosure can be implemented;

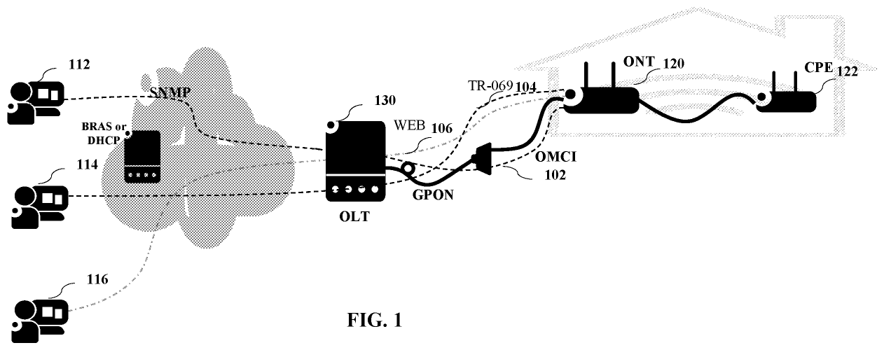

FIG. 2 illustrates an exemplary procedure of authentication by using fixed password;

FIG. 3 illustrates an exemplary procedure of authentication by using per-device password;

FIG. 4 illustrates an exemplary procedure of authentication by using public key;

FIG. 5 illustrates an exemplary procedure of authentication by using X.509 version 3 certificate;

FIG. 6 illustrates an exemplary procedure of authentication according to embodiments of the present disclosure;

FIG. 7 is a diagram depicting a procedure of SSH-based authentication by using password;

FIG. 8 is a diagram depicting a procedure of SSH-based authentication by using public key;

FIG. 9 is a flow chart depicting a method according to an embodiment of the present disclosure;

FIG. 10 is a flow chart depicting a method according to an embodiment of the present disclosure; and

FIG. 11 shows a simplified block diagram of an apparatus according to an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As described above, an authenticated secure channel should be built up between maintenance devices and remote ONT/CPE for providing remote troubleshooting/operation/maintenance. There are several existing schemes can be used for remote connecting. However, each of the existing schemes has some limitations. For example, telnet is a standardized protocol for remote login. It is a clear text protocol, which has no security. Another scheme is to utilize a proprietary OLT (Optical Line Terminal) cut-through channel. This proprietary channel only protects the security between one OLT and one ONT, and it does not work if a third party OLT need to be connected.

Yet another scheme is to utilize a cryptographic protocol, such as Secure Shell (SSH) protocol. However, this protocol also has some limitations in client authentication in some use cases. For example, in some SSH-based authentication, a fix password is used to authenticate a client device. The client device can use the fixed password to login in all server devices in a network. Such fixed password is easy to be disclosed in a long run. Furthermore, there is no validity period for the fixed password, and accordingly the fixed password is non-revocable.

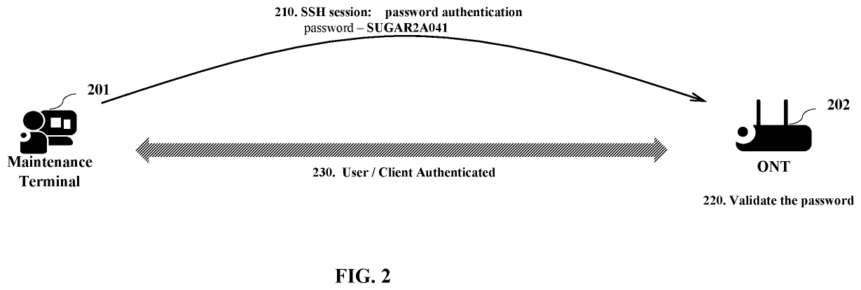

FIG. 2 illustrates an exemplary procedure of authentication by using fixed password. In such use case, a maintenance terminal 201 acts as a client device, and an ONT 202 acts as a server device. When the maintenance terminal 201 needs to login in the ONT 202 remotely, for example to provide services of remote troubleshooting/fixing/maintenance, the maintenance terminal 201 should be authenticated to the ONT 202 firstly. In order to conduct an authentication, the maintenance terminal 201 may send a password (e.g. a string “SUGAR2A041”) to the ONT 202 through an SSH session, as shown at 210. Then, the ONT 202 may validate the received password, as shown at 220. For example, the ONT 202 may match the received password to associated information item, to check if they are mapped to each other. If it is determined that the password is valid, the maintenance terminal is authenticated to the ONT, as shown at 230. In other words, the result of the authentication is success. Otherwise, the result of the authentication is failure.

Although not shown in FIG. 2, the maintenance terminal 201 may use the same password (e.g. the string “SUGAR2A041”) to login other ONT in a network. In some examples, all ONTs of vendor may be login with a same password, and the same password is a fixed password which would not be changed or revoked over time. This is because if different ONT(s) may have different passwords, or if the password may change variously, it would be difficult to manage these passwords for a big mass of ONTs, and would cause confusion in future troubleshooting/operation/maintenance.

As a same fixed password is used in authenticating the maintenance 201 to multiple devices, it is easy to be revealed, for example to the INTERNET in the long run. As the fixed password has no validity period and it is non-revocable, if the fixed password is revealed, all ONTs would be threatened.

In order to alleviates the risk of “one credential for all devices” caused by the fixed password, a per-device password is proposed to be used in SSH-based authentication. In this use case, for each server device, the client device can use a password specific to the server device to login the server device.

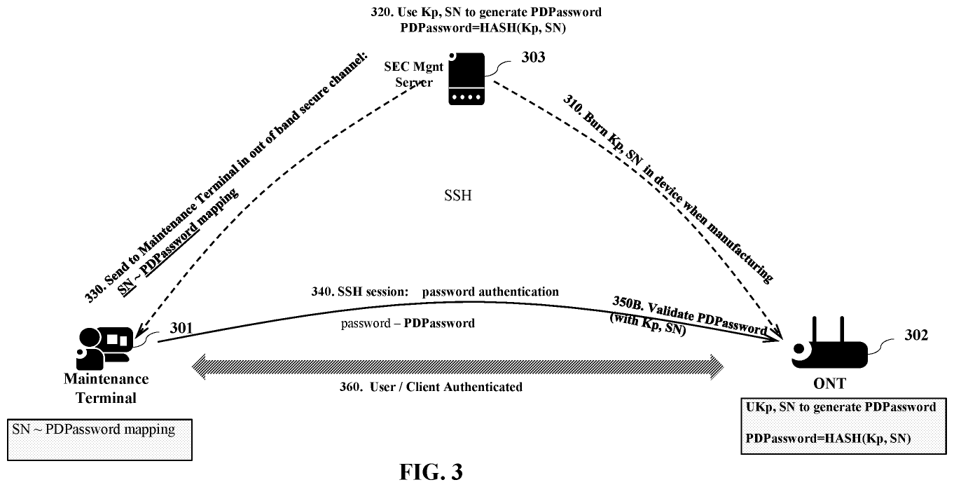

FIG. 3 illustrates an exemplary procedure of authentication by using per-device password. In such use case, a third party may be involved to manage the per-device passwords centrally. As shown in FIG. 3, a security management server 303 may generate a per-device password for each server device (at 320), and issue the per-device password to a client device (at 330). For example, when a maintenance terminal 301 needs to login in a particular ONT 302 remotely, it may send a request including a Serial Number (SN) of the ONT 302 to the security management server 303. In response to the request, the security management server 303 may generate a per-device password of the ONT 302, for example based on the SN and a private key (denoted as Kp) of the ONT 302. For example, the per-device password may be generated through a Hash algorithm, which can be denoted as, PDPassword=HASH (Kp, SN). The generated per-device password can be sent to the maintenance terminal 301 in out-of-band secure channels, such as an email, a removable storage card, and the like.

The private key (Kp) and the Serial Number (SN) may be provided to the ONT 302 from the security management server 303, as shown at 310. For example, Kp and SN can be burn into the ONT 302, when the ONT 302 is being manufactured. Meanwhile, the generation algorithm of the per-device password of the ONT 302 is embedded in the ONT 301. Then, the ONT 302 may generate its per-device password based on the Kp and SN through the generation algorithm. To alleviate the risk of disclosure, the algorithm shall not be embedded in the maintenance terminal, because a maintenance terminal may belong to customers and has potential security risks.

Then, with the received per-device password of the ONT 302, the maintenance terminal 301 may authenticate it to the ONT 302 though a SSH session. As shown at 340, the maintenance terminal 301 may send the per-device password to the ONT 302. Then, the ONT 302 may validate the received per-device password as shown at 350. In this regard, the ONT 302 may compare the received password and the password generated by itself, to check if they are mapped to each other. If it is determined that the password is valid, the maintenance terminal is authenticated to the ONT, as shown at 360. In other words, the result of the authentication is success. Otherwise, the result of the authentication is failure.

In such use case, a reveal of a per-device password for a particular ONT will not threaten other ONT, because their passwords are different. However, the per-device password is still fixed for each ONT, and undertakes the same risk of reveal. In this regard, the per-device password is also easy to be disclosed in the long run. Further, there is no validity period for the password and Kp, and accordingly the password and Kp are non-revocable. Because there is no way to revoke disclosed Kp, Kp and the password generation algorithm shall not be embedded in maintenance terminals. Furthermore, in some scenarios, a maintenance terminal may need to handle remote OAM operations for a big mass of ONT devices, for example by a batch processing. Then, it would be a big bundle for the maintenance terminal to do mapping of SN to per-device passwords for each ONT.

In some SSH-based authentication, a public key is used to authenticate a client device. A client device can hold a public-private key pair and use a public key of the key pair to login a server device. The server device may hold the public key of the key pair. The public-private key pair may be PKI (Public Key Infrastructure) RSA (Rivest-Shamir-Adleman) keys, or other asymmetric keys, such as DSS (Digital Signature Standard) keys, etc. Multiple server devices may use a same public-private key pair. In this use case, there is no validity period for the public-private key pair, and accordingly the public-private key pair is non-revocable.

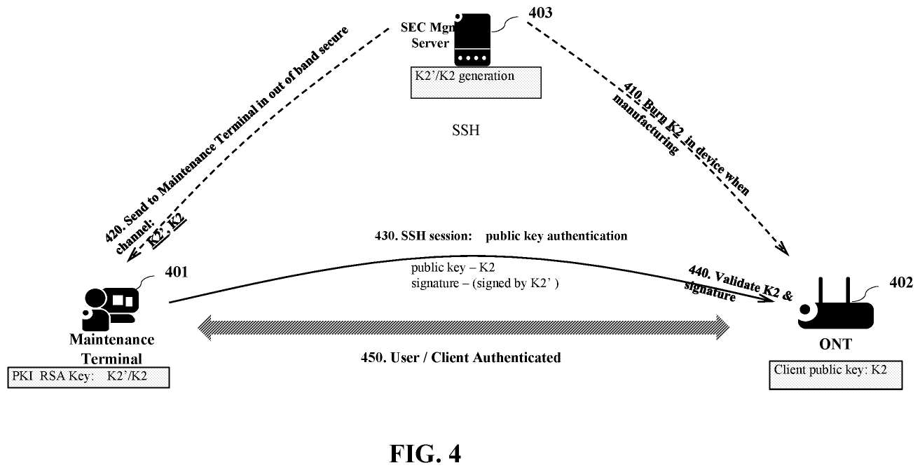

FIG. 4 illustrates an exemplary procedure of authentication with a public key. In such use case, a third party (e.g. a security management server 403) may be involved to manage the public-private key pair centrally. The key pair can be used with an asymmetric cryptographic algorithm for protecting data transfer between a client device and a server device. As shown in FIG. 4, the security management server 403 may generate a pair of public key (denoted as K2) and a private key (denoted as K2′). The public key K2 may be provided to the ONT 402 from the security management server 403, as shown at 410. For example, K2 can be burn into the ONT 402, when the ONT 402 is being manufactured. The security management server 403 may send the public-private key pair to a maintenance terminal 401, for example in out-of-band secure channels, as shown at 420.

When the maintenance terminal 401 needs to login in the ONT 402 remotely, for example to provide services of remote troubleshooting/fixing/maintenance, the maintenance terminal 401 may send the public key K2 with a signature to the ONT 402 through an SSH session, as shown at 430. The public key K2 can be signed with the private key K2′. Then, the ONT 402 may validate the received public key and the signature, as shown at 440. For example, the ONT 402 may match the received public key with its own public key. Alternatively, a fingerprint of the public key can be checked for the validation. If it is determined that the password is valid, the maintenance terminal is authenticated to the ONT, as shown at 450. In other words, the result of the authentication is success. Otherwise, the result of the authentication is failure.

Although not shown in FIG. 4, the maintenance terminal 401 may use the same public key to login other ONT in a network. In some examples, multiple ONTs of vendor may use a same public-private key pair. Normally, the public-private key pair is fixed, and would not be changed or revoked over time. Thus, the public-private key pair is easy to be disclosed to the Internet in a long run. Then all ONTs would be threatened by the key pair, since the key pair has no validity period and is non-revocable.

There is another kind of SSH-based authentication, in which X.509 version 3 certificates is utilized to authenticate a client device. Details of using X.509 version 3 certificates in the SSH-based authentication are described in RFC 6187, which is incorporated herein by reference in its entirety.

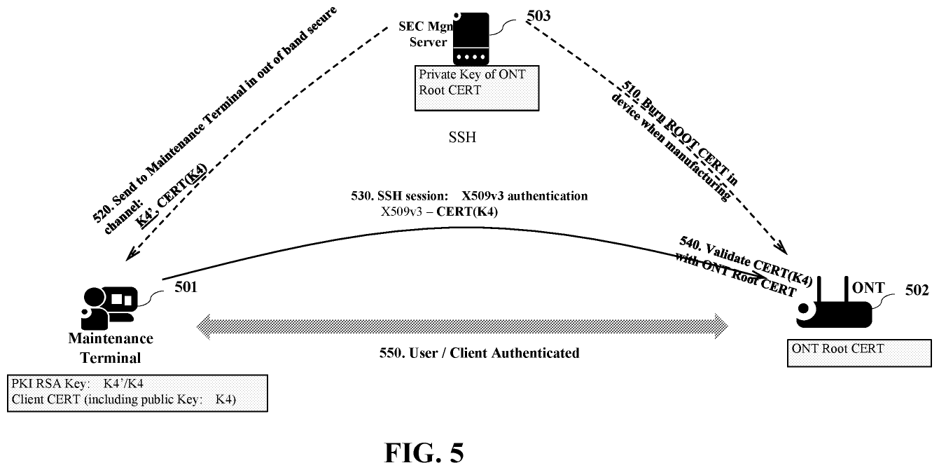

FIG. 5 illustrates an exemplary procedure of authentication by using X.509 version 3 certificates. In such use case, a third party (e.g. a security management server 503) may be involved to manage the certificate centrally. As shown in FIG. 5, the security management server 503 may hold a private key of a root certificate. The root certificate may be provided to the ONT 502 from the security management server 503, as shown at 510. For example, the root certificate can be burn into the ONT 502 as a trusted root certificate, when the ONT 502 is being manufactured.

The security management server 503 may generate and/or hold a public-private key pair (K4, K4′). The public-private key pair may be PKI RSA keys, or other asymmetric keys, such as DSS keys, etc. The security management server 503 may send the private key (K4′) to a maintenance terminal 501, for example in out-of-band secure channels, as shown at 520. The security management server 503 may further send to the maintenance terminal 501 a sub-certificate which is signed by a corresponding private key of the root certificate. The sub-certificate comprises the public key K4. The sub-certificate may be transmitted together with the private key, or separately.

When the maintenance terminal 501 needs to login in the ONT 502 remotely, it may send the sub-certificate to the ONT 502 through an SSH session, as shown at 530. Then, the ONT 502 may validate the received sub-certificate by using its root certificate, as shown at 540. If it is determined that the sub-certificate is valid, the maintenance terminal is authenticated to the ONT, as shown at 550. In other words, the result of the authentication is success. Otherwise, the result of the authentication is failure.

Since the sub-certificate can be utilized for defining a validity period, the credential for this use case is controllable and revocable. One problem for this use case is that X.509 version 3 is not supported in most popular existing SSH applications. One statistic of SSH applications (at http://ssh-comparison.quendi.de/comparison/hostkey.html) shows that currently, only two SSH applications (asynsSSH and smartFTP) support X.509 version 3.

This disclosure proposes an improved public-key scheme to authenticate remote client (e.g. a maintenance terminal) based on SSH, with the advantages of controllable validity period, revocable public key, compatible with most existing SSH applications, etc. The proposed scheme is based on an SSH-based authentication with public key and an SSH-based authentication with password, and is compatible with all existing SSH applications. It improves the normal authentication by taking two-steps authentication.

In a first step, a client device is authenticated with password or public key though a first SSH session. The password may be a fixed password. The first SSH session based on password or public key may be performed as shown in FIGS. 2-4. However, after a successful authentication in the first SSH session, the client device is only allowed to copy a credential to a server device (e.g. an ONT). The credential may be a self-issued certificate with a public key, which may be used for a second SSH session of a second authentication step. The credential can be verified by a customized application in the server device. In this sense, the authentication of the first SSH session can be taken as a partial authentication.

Then, in the second step, the client device is authenticated though the second SSH session, with a new public key which is contained in the certificate after a successful authentication in the first SSH session. The second SSH session based on public key may be performed as shown in FIG. 4. While this public key is endorsed by the validated certificate, it has all the properties of a certificate, such as controllable validity period, revocable credential, etc. Moreover, extra conditions can be put in the certificate to restrict the usage scope of the public key. For example, an identifier of Operator_ID can be embedded in the certificate to indicate that the public key and the related public-private key pair are valid for a defined operator (or customer) only.

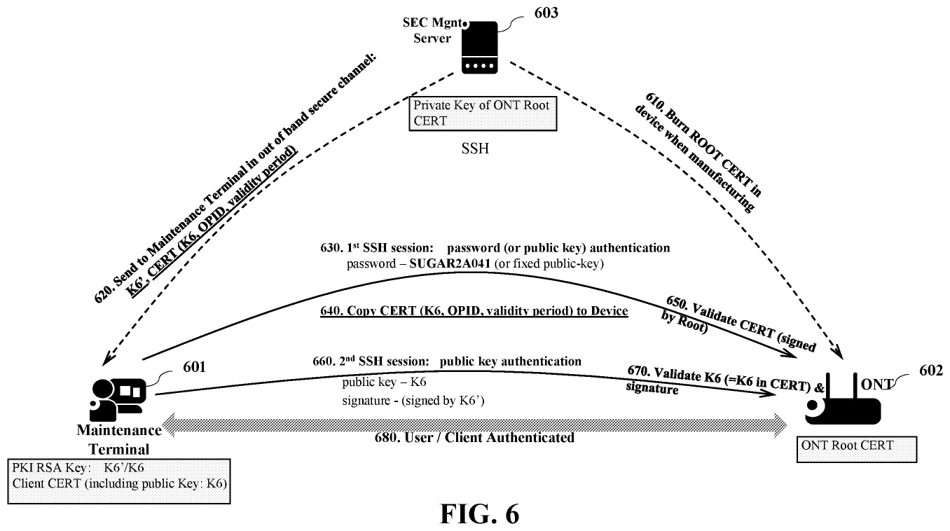

FIG. 6 illustrates an exemplary procedure of authentication according to embodiments of this disclosure. In such embodiment, a third party (e.g. a security management server 603) may be involved to manage a public-private key pair and certificate centrally. The security management server may act as ONT Root CA (Certificate Authority). As shown in FIG. 6, the security management server 603 holds a private key of a root certificate. The root certificate may be self-signed by the security management server 603 with its private key. The root certificate may be provided to the ONT 602 from the security management server 603, as shown at 610. For example, the root certificate can be burn into the ONT 602 as a trusted root certificate, when the ONT 602 is being manufactured.

The security management server 603 may generate a public-private key pair (K6, K6′). The public-private key pair may be PKI RSA keys, or other asymmetric keys, such as DSS keys, etc. The security management server 603 may send a private key K6′ to a maintenance terminal 601, for example in out-of-band secure channels, as shown at 620. The security management server 603 may further send to the maintenance terminal 601 a sub-certificate which is signed by the private key of the root certificate. The public key K6 of the public-private key pair is wrapped in the sub-certificate which is signed by the root certificate. The sub-certificate may be transmitted together with the private key K6′, or separately. In an example, the sub-certificate may further comprise a validity period indicating a life of the public-private key pair. The sub-certificate may further comprise an identifier to restrict a usage scope of the public key K6. For example, the identifier may be an Operator ID to indicate that the public key K6 can be used for login in ONTs of an operator identified with the Operator ID.

In some embodiments, the sub-certificate may be signed by a private key of an up level of sub-certificate, which may be authorized by the root certificate. The up level of sub-certificate may be hold by the security management server 603 or other network entities, which may be collectively called as “an original CA (certificate authority)” of the up level of sub-certificate. A CA could issue certificate to its' subordinate CA, or to end user directly. For example, the up level of sub-certificate may be provided to the ONT 602 in a similar way as step 610.

When the maintenance terminal 601 needs to login in the ONT 602 remotely, it may conduct a partial authentication via a first SSH session. The first SSH session may use a fixed password or a fixed public key to authenticate the maintenance terminal 601 to the ONT 602. As shown at 630, the maintenance terminal 601 may send a password to the ONT 602, and the ONT 602 may validate the received password. The first SSH session at 630 may be performed in a similar way as the SSH session at 210, 220.

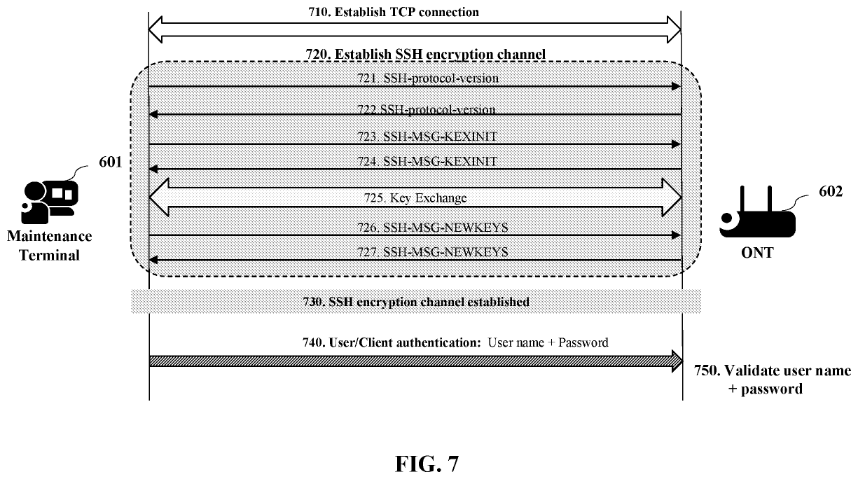

FIG. 7 illustrates an exemplary procedure of an SSH session by using password for authentication. As shown at 710, a TCP (Transmission Control Protocol) connection is established between a maintenance terminal 601 and an ONT 602. Next, the maintenance terminal 601 and the ONT 602 may try to establish an SSH encryption channel their between. In this regard, they may negotiate an SSH protocol version to be used as shown at 721 and 722, and exchange messages for initiating an exchange of keys at 723 and 724. Then, they may exchange keys at 725 and exchange message of new keys at 726 and 727. Next at 730, an SSH encryption channel are established between the maintenance terminal 601 and the ONT 602. Next at 740, the maintenance terminal 601 may transmit a request for password authentication to the ONT 602 over the established SSH encryption channel. The request may comprise a password and an associated user name. The password and user name may be inputted by a user of the maintenance terminal 601. Then the ONT 602 may interpret the received password and validate it as shown at 750. For example, the ONT 601 may compare the password and user name against existing items in a password database. If the password is validated, it means that the authentication has been successfully complete. For example, the ONT 601 may reply to the request message with an indication of a result of the authentication, e.g. success or failure (if the password isn't validated).

Alternatively, the first SSH session may use a public key authentication. In this regard, the maintenance terminal 601 may send a public key to the ONT 602 and then the ONT 602 may validate the received public key. It should be noted that this public key for authentication in the first SSH session is not the public key in the sub-certificate, but a fixed public key as that used in a normal public key authentication. For example, the security management server 603 may send a fixed public-private key pair (K2, K2′) to the maintenance terminal 601 and provide the fixed public key K2 to the ONT 601, in a similar way as the procedure of FIG. 4.

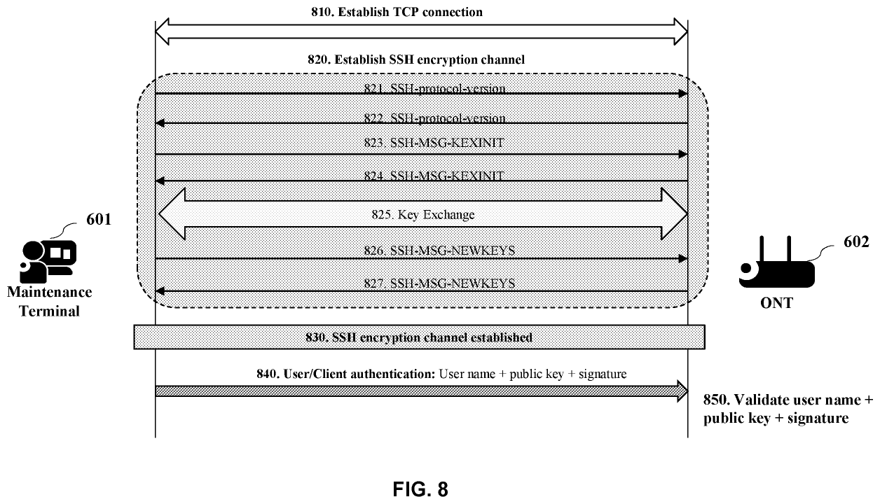

The first SSH session at 630 may be performed in a similar way as the SSH session at 430, 440. FIG. 8 illustrates an exemplary procedure of an SSH session by using public key for authentication. Similar as the procedure of password authentication method, a TCP (Transmission Control Protocol) connection is established between a maintenance terminal 601 and an ONT 602 at 810, and then the maintenance terminal 601 and the ONT 602 may try to establish an SSH encryption channel their between as show at 820 and 830.

Next at 840, the maintenance terminal 601 may transmit a request for public key authentication to the ONT 602 over the established SSH encryption channel. The request may comprise a user name, a public key K2, and a signature. The signature may be signed by a private key K2′ of the maintenance terminal 601 over the user name, the public key K2 and a session id of the first SSH session. When the ONT 602 receives this request, it may validate the user name, the public key K2, and the signature. In this regard, the ONT 602 may use the received public key K2 to validate the signature. Then, a successful validation means the maintenance terminal 601 (which sends out K2) really possesses the private key K2′ (signed the signature).

Details of an SSH-based authentication using password or public key are described in RFC 4252, which is incorporated herein by reference in its entirety.

Reference is made back to FIG. 6. In this first SSH session, the authentication of the maintenance terminal 601 (i.e. the client device) is not trusted, because a fixed password (e.g. “SUGAR2A041”) or a fixed public-key is used. As discussed above, the fixed password (e.g. “SUGAR2A041”) and the fixed public-key are easy to be disclosed in a long run. As such, the maintenance terminal are allowed to do limited interworking operations with the ONT, in response to a successful authentication of the first Secure Shell session are limited. In this regard, limited data including a copy of the sub-certificate, are allowed to be transferred between the maintenance terminal 601 and the ONT 602, as shown at 640.

In an embodiment, “copy a sub-certificate of a client device to a server device” may be the only operation allowed to be done in response to a successful authentication of the first SSH session. Other operation may also be allowed, while these operations shall not impact the security, e.g. has no risk of STRIDE (Spoofing, Tampering, Repudiation, Information disclosure, Denial of Service, Elevation of privilege).

The sub-certificate may be issued per operator which is identified with an indicator, “OPID”. In this regard, the sub-certificate for a particular operator may be used for login in all or part of ONTs of the particular operator. The sub-certificate may contain an information group of (K6, OPID, validity period). The ONT 602 may validate the received sub-certificate by a customized application running in the ONT. For example, the ONT 602 may validate the received sub-certificate by doing at least one of the following checks,

1. check the signature of the sub-certificate;

2. check whether the sub-certificate is not in a certificate revocation list (CRL), e.g. a local CRL in the ONT 602;

3. check whether the OPID in the sub-certificate match a pre-configured OPID in the ONT 602;

4. check whether the validity period in the sub-certificate is expired.

The signature of the sub-certificate can be validated by using the root certificate or its up-level certificate. If the signature of the sub-certificate is signed by ONT Root CA or its original CA, the sub-certificate can be validated. If the sub-certificate is not in a certificate revocation list (CRL), e.g. a local CRL in the ONT 602, the sub-certificate may be validated. If the OPID in the sub-certificate match a pre-configured OPID, the sub-certificate may be validated. With regard to the validity period, the ONT 602 may verify it against its own system clock, which may have been calibrated with NTP (Network Time Protocol). If the validity period is not expired, the sub-certificate can be validated. If all of the checks are passed, the ONT 602 may determine that the received sub-certificate can be trustable, and the public key K6 in the sub-certificate can be trustable.

It should be noted that in embodiments of this disclosure, the sub-certificate is transferred from the maintenance terminal to the ONT as traffic data transferred over an SSH encryption channel established in the first SSH session after an authentication, instead of protocol data transferred for SSH authentication as X.509 version 3 authentication.

Next, a second SSH session is performed by using the new public key K6 to authenticate the maintenance terminal 601 to the ONT 602. The second SSH session may be performed in a similar way as the SSH session at 430, 440, or the procedure shown in FIG. 8. In particular, the maintenance terminal 601 may send a request for public key authentication to the ONT 602, as shown at 660. The request comprises the new public key K6. When the ONT 602 receives this request, it may validate the new public key K6. In this regard, the ONT 602 may compare the new public key K6 with the public key in the sub-certificate as shown at 670. If the public keys is matched to each other, the second SSH session is successful, and it means that the maintenance terminal 601 possesses the private key K6′ mapping to K6. Then, the maintenance terminal 601 is authenticated to the ONT 602 and trusted by the ONT 602.

Embodiments of this disclosure may provide following advantages. Firstly, PKI (Public Key Infrastructure) public-private key pair (K6, K6′) can be managed in a central security management server, which is generally safe. The public key K6 (in a sub-certificate) is signed by a root certificate, and is used by a device to authenticate a client device (e.g. a maintenance terminal). By adjusting the parameters in the self-issued sub-certificate, the central security management server can control a validity period, effectiveness, usage scope of the PKI public-private key pair. In this regard, for example, the root certificate is a first level of certificate, and the sub-certificate may be a second level, or third level, or other lower level of certificate. The lower level of certificate can be set up to manage the PKI keys of a client device. The lower level of certificate is endorsed by an up level of certificate of its original certificate authority.

In embodiments of this disclosure, a validity period of PKI keys for a client device can be managed. For example, short-term keys can be issued for transient troubleshooting/operation/maintenance task to alleviate the risk of disclosure. Client's PKI keys will be invalid naturally after an expiry date defined by the validity period, and accordingly be rejected by the server (or device). There is no need to manage outdated keys even if they're disclosed.

Furthermore, a private key of a PKI keys for a client will never be transmitted over a SSH session in embodiments of this disclosure. Even if it's disclosed by some hacker/mole during validity, the related certificate can be revoked in a sever CRL via a secure OAM channel (e.g. OMCI, TR69, etc.). So, that disclosed keys will be rejected by the server device (e.g. ONT in FIG. 6).

As discussed above, in some embodiments, extra conditions can be defined in the self-issued certificate to restrict the usage scope of the new public key. For example, an indication of OPID (operator ID) can be embedded in certificate to define a valid operator (or customer) that uses the certificate. Public key binding to some OPIDs will be rejected by the server device (e.g. ONT in FIG. 6) which has been configured to a different OPID (or belong to a different customer).

In embodiments of this disclosure, SSH user authentication protocols used in the first SSH session and the second SSH session are based on password, and public key. This is compatible with almost all existing SSH applications. Based on compatible authentication, embodiments of this disclosure provide a flexible X.509 version 3 client authentication for SSH, meanwhile it's not required to support RFC6187. (RFC6187 is not supported in most popular SSH applications, as discussed above.)

It should be appreciated that the proposed scheme of this disclosure can be used in any remote authentication for computing devices in a relationship of client/server. Embodiments of this disclosure can be used to provide secure connections between a maintenance terminal and other remote devices especially those that have no dedicated secure channel for remote troubleshooting/operation/maintenance. For example, it can be applied to provide secure connections between a maintenance terminal and a CPE for handling remote troubleshooting/operation/maintenance. In another example, a WiFi terminal may act as a server device, and the maintenance terminal may act as a client device which needs to remotely login in the WiFi terminal for handling remote troubleshooting/operation/maintenance. In this use case, WiFi terminals may work behind RGW (Residential Gateway), and have no public IP address. Then, an SSH reverse tunnel need to be be set up from WiFi terminals to the maintenance terminal before the first SSH session. After that, the procedures of copying certificate to WiFi terminals (as shown in 640) and authenticating the client device with a new public key (as shown in 660 and 670) are the same as the procedure for ONTs.

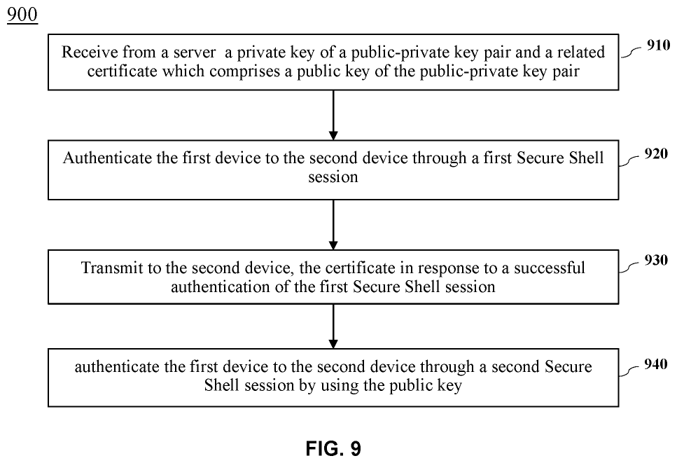

Reference is now made to FIG. 9, which illustrates a flowchart of a method for authenticating the first device to the second device according to some embodiments of the disclosure. The method 900 can be performed at a client device, such as a maintenance terminal 601 as shown in FIGS. 6, 7 and 8. As shown at block 910, the method 900 comprises receiving from a server (e.g. the security management server 603), a private key of a public-private key pair and a related certificate. The certificate comprises a public key of the public-private key pair.

At block 920, the procedure of the method proceeds to authenticate the first device to the second device (e.g. the ONT 602) through a first Secure Shell session. In the first Secure Shell session, a password or a fixed public key of the first device can be sent to the second device, so that the first device is authenticated based on the password or the fixed public key.

At block 930, the procedure proceeds to transmit to the second device, the certificate in response to a successful authentication of the first Secure Shell session. The certificate may be signed by a certificate of an original certificate authority. The certificate may further comprise at least one of a validity period defining a valid period of the public key, and an indication indicating a usage scope of the public key. The certificate may be an X.509 version 3 certificate. The transmitting of the certificate may be the only operation allowed to be done in response to a successful authentication result of the first Secure Shell session.

At block 940, the procedure proceeds to authenticate the first device to the second device through a second Secure Shell session by using the public key. In the second Secure Shell session, the public key can be sent to the second device.

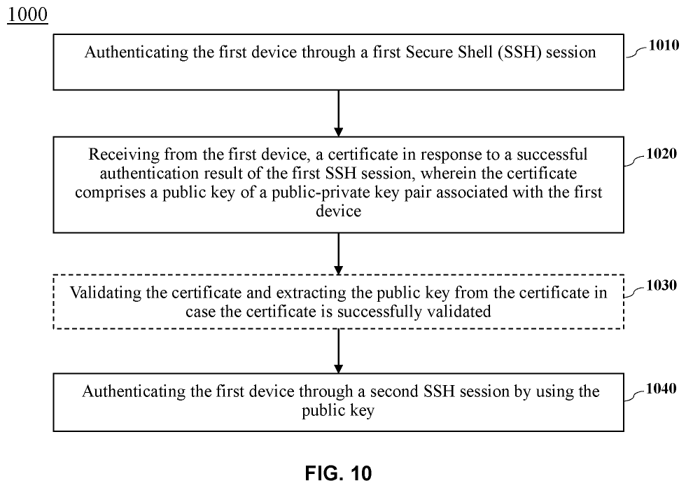

Reference is now made to FIG. 10, which illustrates a flowchart of a method for authenticating the first device to the second device according to some embodiments of the disclosure. The method 1000 can be performed at a server device, such as an ONT 602 as shown in FIGS. 2-8. As shown at block 1010, the method 1000 comprises authenticating the first device (e.g. a maintenance terminal 601) through a first Secure Shell (SSH) session. In the first SSH session, the second device may receive from the first device, a password or a fixed public key to authenticate the first device based on the password or the fixed public key.

As shown at 1020, the method further comprises receiving from the first device, a certificate in response to a successful authentication result of the first SSH session. The certificate comprises a public key of a public-private key pair associated with the first device. The certificate is signed by a private key of a certificate of an original certificate authority.

As shown at 1030, the method may further comprise validating the certificate by doing at least one of the following checks: check the signature of the certificate, check the certificate against a certificate revocation list, check the usage scope against a pre-configured condition, and check whether the validity period is expired. The method may further comprise extracting the public key from the certificate in case the certificate is successfully validated.

As shown at 1040, the method further comprises authenticating the first device through a second SSH session by using the public key. In the second SSH session, the second device may receive the public key to the second device; and validate the received public key against the public key in the certificate.

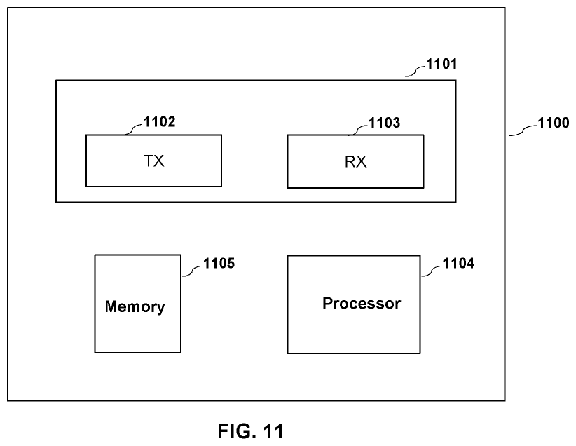

FIG. 11 shows a simplified block diagram of an apparatus according to an embodiment of the present disclosure. The apparatus 1100 can be implemented as a client device (e.g. a maintenance terminal) or a server device (e.g. an ONT) or a module thereof as shown in FIG. 2-8. As shown in FIG. 11, the apparatus 1100 comprises a processor 1104, a memory 1105, and a transceiver 1101 in operative communication with the processor 1104. The transceiver 1101 comprises at least one transmitter 1102 and at least one receiver 1103. While only one processor is illustrated in FIG. 11, the processor 1104 may comprises a plurality of processors or multi-core processor(s). Additionally, the processor 1104 may also comprise cache to facilitate processing operations. For some same or similar parts which have been described with respect to FIGS. 2-8, the description of these parts is omitted here for brevity.

Computer-executable instructions can be loaded in the memory 1105 and, when executed by the processor 1104, cause the apparatus 1100 to implement the above-described methods.

Additionally, an aspect of the disclosure can make use of software running on a computing device. Such an implementation might employ, for example, a processor, a memory, and an input/output interface formed, for example, by a display and a keyboard. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, random access memory (RAM), read only memory (ROM), a fixed memory device (for example, hard drive), a removable memory device (for example, diskette), a flash memory and the like. The processor, memory, and input/output interface such as display and keyboard can be interconnected, for example, via bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

As noted, aspects of the disclosure may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a RAM, ROM, an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

Computer program code for carrying out operations for aspects of the disclosure may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

The flowchart and block diagrams in the figures illustrate the architecture, functionality, and operation of possible implementations of systems, methods and computer program products according to various embodiments of the disclosure. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially simultaneously, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In any case, it should be understood that the components illustrated in this disclosure may be implemented in various forms of hardware, software, or combinations thereof, for example, application specific integrated circuit(s) (ASICS), functional circuitry, an appropriately programmed general purpose digital computer with associated memory, and the like. Given the teachings of the disclosure provided herein, one of ordinary skill in the related art will be able to contemplate other implementations of the components of the disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. It will be further understood that the terms “comprises”, “containing” and/or “comprising,” when used in this specification, specify the presence of stated features, integers, steps, operations, elements, and/or components, but do not preclude the presence or addition of another feature, integer, step, operation, element, component, and/or group thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1-30. (canceled)

31. An apparatus at a first device for authenticating the first device to a second device, comprising:
at least one processor;
at least one memory including computer program code, the memory and the computer program code configured to, working with the at least one processor, cause the apparatus to:
receive from a server, a private key of a public-private key pair and a related certificate, wherein the certificate comprises a public key of the public-private key pair;
authenticate the first device to the second device through a first Secure Shell session;
transmit to the second device, the certificate in response to a successful authentication through the first Secure Shell session; and
authenticate the first device to the second device through a second Secure Shell session by using the public key.

32. The apparatus according to claim 31, wherein the memory and the computer program code is configured to, working with the at least one processor, further cause the apparatus to, send to the second device in the first Secure Shell session, a password or a fixed public key of the first device, so that the first device is authenticated based on the password or the fixed public key.

33. The apparatus according to claim 31, wherein the memory and the computer program code is configured to, working with the at least one processor, further cause the apparatus to,
send the public key to the second device in the second Secure Shell session.

34. The apparatus according to claim 31, wherein the certificate is signed by a private key of a certificate of an original certificate authority.

35. The apparatus according to claim 34, wherein the certificate further comprises at least one of the following items:
a validity period defining a valid period of the public key; and
an indication indicating a usage scope of the public key.

36. The apparatus according to claim 31, wherein the certificate is an X.509 version 3 certificate.

37. An apparatus at a second device for authenticating a first device, comprising:
at least one processor;
at least one memory including computer program code, the memory and the computer program code configured to, working with the at least one processor, cause the apparatus to:
authenticate the first device through a first Secure Shell session;
receive from the first device, a certificate in response to a successful authentication result of the first Secure Shell session, wherein the certificate comprises a public key of a public-private key pair associated with the first device; and
authenticate the first device through a second Secure Shell session by using the public key.

38. The apparatus according to claim 37, wherein the memory and the computer program code is configured to, working with the at least one processor, further cause the apparatus to,
receive from the first device in the first Secure Shell session, a password or a fixed public key to authenticate the first device based on the password or the fixed public key.

39. The apparatus according to claim 38, wherein the memory and the computer program code is configured to, working with the at least one processor, further cause the apparatus to,
receive the public key to the second device in the second Secure Shell session; and
validate the received public key against the public key in the certificate.

40. The apparatus according to claim 37, wherein the certificate is signed by a private key of a certificate of an original certificate authority.

41. The apparatus according to claim 40, wherein the certificate further comprises at least one of the following items:
a validity period defining a valid period of the public key; and
an indication indicating a usage scope of the public key.

42. The apparatus according to claim 41, wherein the memory and the computer program code is configured to, working with the at least one processor, further cause the apparatus to,
validate the certificate by doing at least one of the following checks,
check the signature of the certificate,
check the certificate against a certificate revocation list,
check the usage scope against a pre-configured condition, and
check whether the validity period is expired; and
extract the public key from the certificate in case the certificate is successfully validated.

43. The apparatus according to claim 37, wherein the certificate is an X.509 version 3 certificate.

44. A method at a second device for authenticating a first device, the method comprising:
authenticating the first device through a first Secure Shell session;
receiving from the first device, a certificate in response to a successful authentication result of the first Secure Shell session, wherein the certificate comprises a public key of a public-private key pair associated with the first device;
authenticating the first device through a second Secure Shell session by using the public key.

45. The method according to claim 44, wherein authenticating the first device through the first Secure Shell session comprises,
receiving from the first device, a password or a fixed public key to authenticate the first device based on the password or the fixed public key.

46. The method according to claim 44, wherein authenticating the first device to the second device through the second Secure Shell session comprises,
receiving the public key to the second device; and
validating the received public key against the public key in the certificate.

47. The method according to claim 44, wherein the certificate is signed by a private key of a certificate of an original certificate authority.

48. The method according to claim 47, wherein the certificate further comprises at least one of the following items:
a validity period defining a valid period of the public key; and
an indication indicating a usage scope of the public key.

49. The method according to claim 48, further comprises,
validating the certificate by doing at least one of the following checks,
check the signature of the certificate,
check the certificate against a certificate revocation list,
check the usage scope against a pre-configured condition, and
check whether the validity period is expired; and
extracting the public key from the certificate in case the certificate is successfully validated.

50. The method according to claim 44, wherein the certificate is an X.509 version 3 certificate.
